(19) United States
(12) Patent Application Publication
(10) Pub. No.: US 2015/0378970 A1
(43) Pub. Date: Dec. 31, 2015

(54) METHOD FOR DISPLAYING WEBPAGES

(71) Applicant: Weiou, Inc., Piedmont, CA (US)

(72) Inventor: Qiuyuan LIU, Piedmont, CA (US)

(21) Appl. No.: 14/747,752

(22) Filed: Jun. 23, 2015

Related U.S. Application Data
(60) Provisional application No. 62/017,265, filed on Jun. 26, 2014.

(51) Int. Cl. G06F 17/22; G06F 17/30; G06F 17/21

(52) U.S. Cl. CPC G06F 17/2247; G06F 17/212; G06F 17/3087; G06F 17/30321

(57) ABSTRACT

A method for displaying webpages comprises: submitting, by a client, a link to a webpage providing a perspective on a subject to a service provider; extracting, by the service provider, the perspective from the webpage, indexing the extracted perspective on the subject, and storing the indexed perspective in a perspective database which stores all indexed perspectives on the subject from different webpages; retrieving, by the client, references to other perspectives on the subject from the service provider; and displaying, by the client, the references to other perspectives on the subject when displaying the webpage.

### CROSS-REFERENCE TO RELATED APPLICATIONS

This application claims the benefit and priority of provisional application No. 62/017,265 filed on Jun. 26, 2014, which is incorporated herein in their entirety by reference.

### TECHNICAL FIELD

The disclosed embodiments relate to a method for displaying webpages.

### BACKGROUND

Nowadays search engines are widely used to explore a subject where the search engine provides a list of relative links to various webpages. One problem with this mechanism is that the links in the result list may point to perspectives that are similar to, or even the same as each other, especially when the main theme of such perspectives is popular. Newly developed perspectives or unpopular perspectives usually have little or no chance to be listed on top of the result list so that a user needs to walk through the result list to reach such perspectives. If the user misses one of the newly developed perspectives or unpopular perspectives, he or she will risk getting an incomplete understanding and missing a whole picture of a subject.

Another problem is that the keywords used by a user to search may not find webpages of perspectives that do not contain such keywords but are indexed under different keywords. In this situation if the user fails to use correct keywords in searching, he or she will also risk missing perspectives and getting incomplete information about a subject.

For example in the history of telephone, it is said Bell and his partners offered to sell the telephone patents to Western Union for $100,000 but were refused because the invention was deemed no more use than an electrical toy. The story has been often quoted as a classic case study of stupid business decisions which overlooked a disruptive technology. It is so popular that the majority of webpages about Bell and Western Union take this perspective and that when searching for “Bell Western Union sell patent” most of the result links point to this perspective, even Wikipedia. FIG. 1(a) shows an article about Alexander Graham Bell on Wikipedia.

Only one webpage published in 2011 takes a different perspective which believes it is a made-up story. FIG. 1(b) illustrates this perspective. With this perspective the user knows there is a possibility that the story or part of the story is not true.

As the above-mentioned example shows, there are times a user will need to walk through many links, which oftentimes are duplicate, pointing to the same or similar perspectives in a search result to get a new perspective or an unpopular perspective, which is inefficient; or a user needs to try various different keywords to find a link to a less popular perspective, which when the user fails he or she gets an incomplete understanding of a subject.

### SUMMARY

Embodiments of the present invention are directed to a method for displaying webpages.

According to one or more embodiments of the present invention, there is provided a method for displaying webpages, comprising: submitting, by a client, a link to a webpage providing a perspective on a subject to a service provider; extracting, by the service provider, the perspective from the webpage, indexing the extracted perspective on the subject, and storing the indexed perspective in a perspective database which stores all indexed perspectives on the subject from different webpages; retrieving, by the client, references to other perspectives on the subject from the service provider; and displaying, by the client, the references to other perspectives on the subject when displaying the webpage.

With the embodiments of the present invention, a first perspective can be linked to a second perspective that is developed or become available after the first perspective is created, and different perspectives of one subject can be cross linked together to provide a whole picture of the subject.

### BRIEF DESCRIPTION OF DRAWINGS

These and other aspects will become apparent and more readily appreciated from the following description of the embodiments, taken in conjunction with the accompanying drawings in which:

FIG. 1(a) illustrates an article about Alexander Graham Bell from Wikipedia;

FIG. 1(b) illustrates a different perspective about the patent selling story shown in FIG. 1(a);

FIG. 2 is a flowchart of a method of displaying webpages according to an embodiment of the present invention;

FIG. 3 illustrates the process of creating a webpage and submitting a link to the webpage to a service provider;

FIG. 4 illustrates the process of displaying the webpage when there is no reference available;

FIG. 5 illustrates the process of creating two webpages and submitting links to the webpages to a service provider;

FIG. 6 illustrates the process of displaying the webpage when there is one reference available;

FIG. 7 illustrates a webpage referring to another webpage which is created later;

FIG. 8 illustrates an example of mapping and linking relationships among webpages;

FIG. 9 illustrates an example of information extraction;

FIG. 10 illustrates the process of using a thesaurus to link perspectives;

FIG. 11 illustrates an example of duplicate perspectives;

FIG. 12 illustrates an example of hit counter; and

FIG. 13 illustrates comparison of the method according to an embodiment of the present invention and an existing search engine.

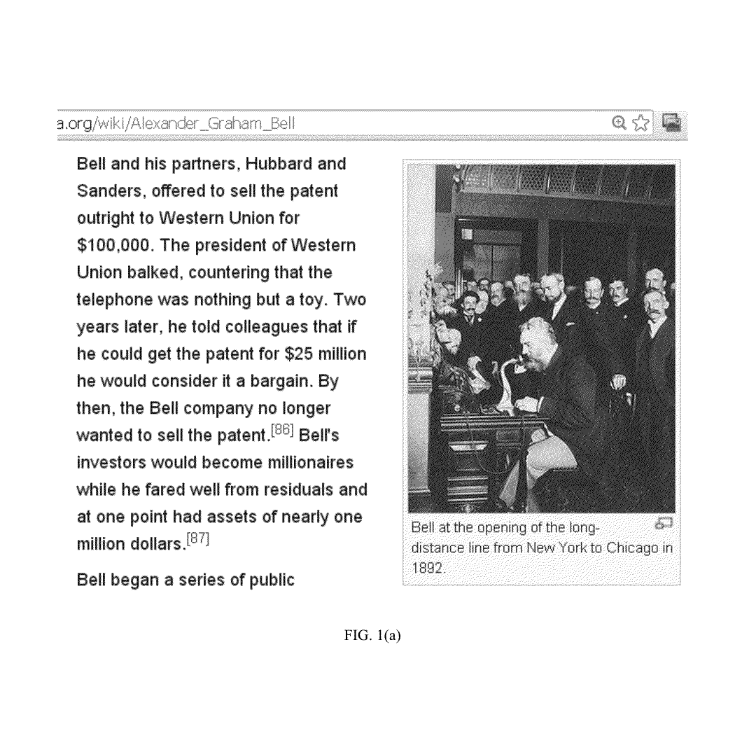

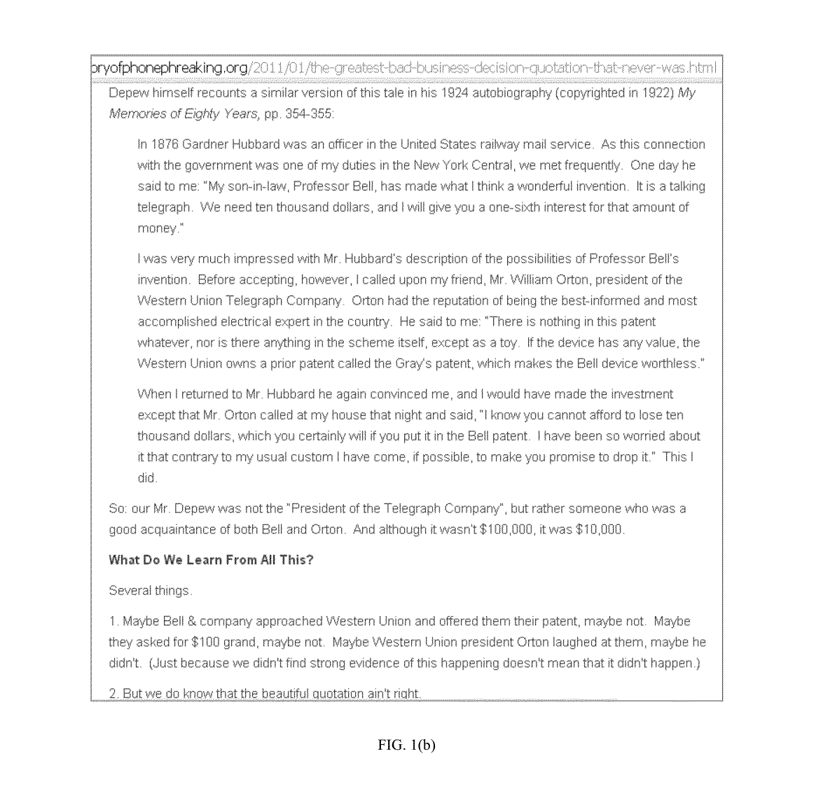

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

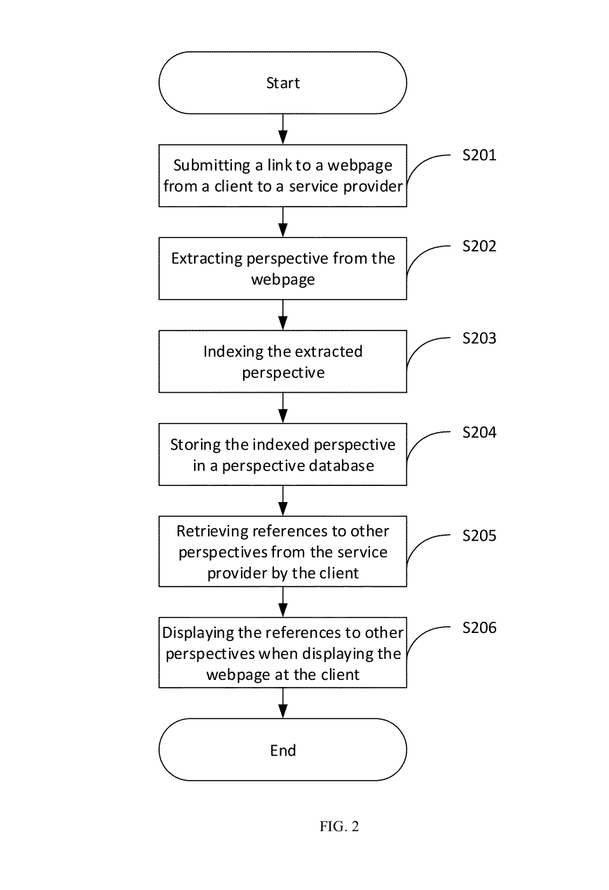

FIG. 2 is a flowchart of a method of displaying webpages according to an embodiment of the present invention.

As shown in FIG. 2, at step S201, a client, for example a personal computer (PC) or a smart phone, submits a link to a webpage providing a perspective on a subject to a service provider, for example a server.

At step S202, the service provider extracts the perspective from the webpage.

At step S203, the service provider indexes the extracted perspective on the subject.

At step S204, the service provider stores the indexed perspective in a perspective database. Here, the perspective database stores all indexed perspectives on the same subject from different webpages.

At step S205, when the webpage is to be displayed, the client retrieves references to other perspectives on the subject from the service provider.

Lastly, at step S206, the client displays the references to other perspective on the subject when displaying the webpage.

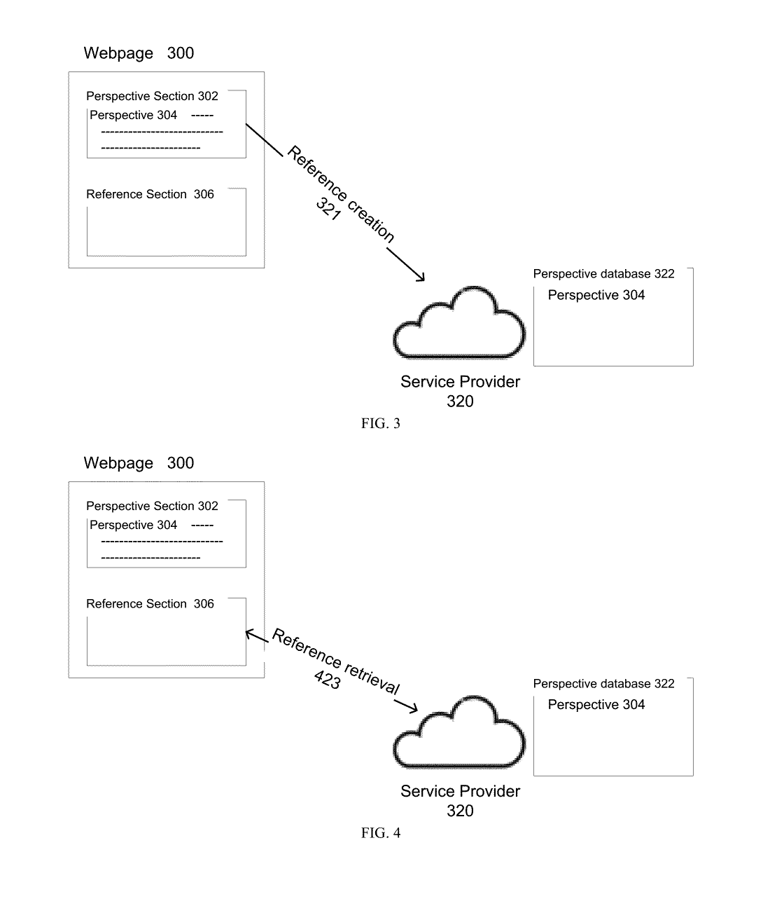

More details will be given thereinafter with reference to FIGS. 3-13 to further explain the steps of the method of displaying webpages.

FIG. 3 illustrates the process of creating a webpage and submitting a link to the webpage to a service provider. As shown in FIG. 3, a webpage 300 is created at a client. The webpage 300 includes a perspective section 302 for providing a perspective 304 on a subject and a reference section 306 for providing references. A link to the webpage 300, for example Uniform Resource Locator (URL) of the webpage 300, is submitted 321 to a service provider 320. The client may submit the link to the webpage 300 to the service provider 320 automatically, or upon request of the service provider 320. Alternatively, an author of the webpage 300 or a viewer of the webpage 300 may submit the link manually through a certain interface or tool provided by the service provider 320. After extracting and indexing the perspective 304 which will be described later, the service provider 320 stores the indexed perspective 304 in a perspective database 322.

FIG. 4 illustrates the process of displaying the webpage when there is no reference available. As shown in FIG. 4, when the webpage 300 is to be displayed, the client goes to the service provider 320 to retrieve 423 references to any available perspectives of the same subject. In this embodiment, only one perspective 304, which is extracted from the webpage 300 itself, is in the perspective database 322. There are no other perspectives retrieved and displayed in the reference section 306. Reference section 306 serves as a place holder for any perspectives which are related to the same subject but may be developed in the future, i.e., after the webpage 300 is created.

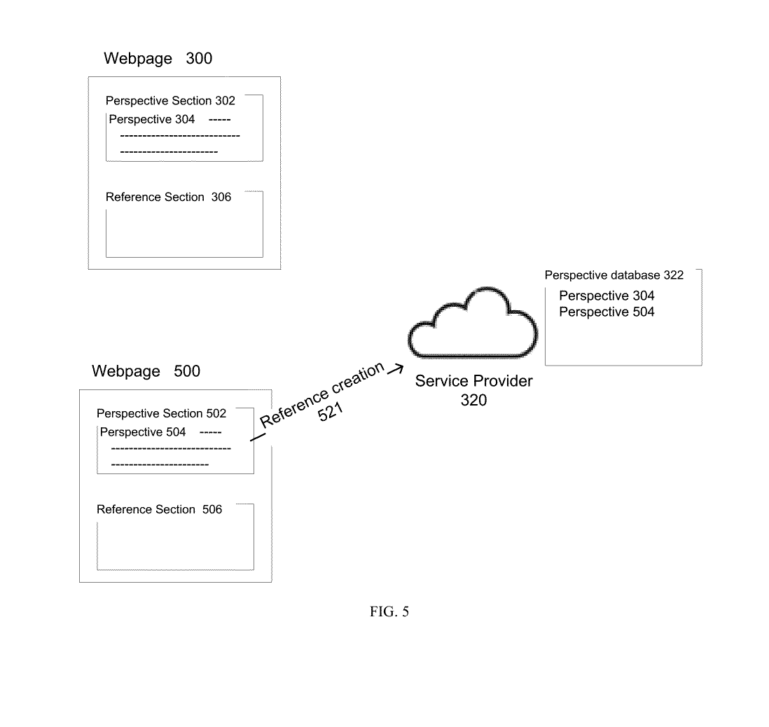

FIG. 5 illustrates the process of creating two webpages and submitting links to the webpages to a service provider. As shown in FIG. 5, a webpage 500 with a perspective section 502 and a reference section 506 is created. The URL of the webpage 500 is submitted 521 to the service provider 320 by various means as described with reference to FIG. 3 above. As a perspective 504 is on the same subject as the perspective 304, the service provider 320 stores them both indexed under the same subject in the perspective database 322.

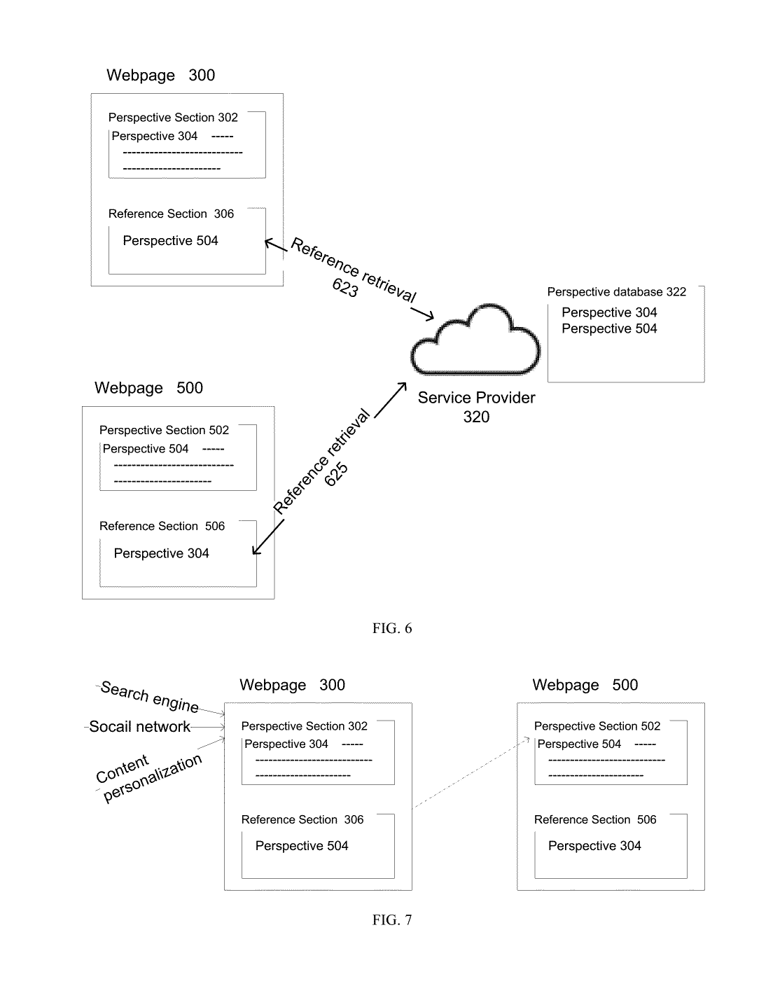

FIG. 6 illustrates the process of displaying a webpage when there is one reference available. As shown in FIG. 6, when the webpage 300 is to be displayed, the client goes to the service provider 320 to retrieve 623 references to any other perspectives on the same subject. In this embodiment, besides the perspective 304 there is the perspective 504 for the same subject in the perspective database 322. A link to the perspective 504 is retrieved 623 and displayed in the reference section 306 of the webpage 300. Similarly, when the webpage 500 is to be displayed, a link to the perspective 304 is retrieved 625 and displayed in the reference section 506 of the webpage 500. The retrieved link in the reference sections 306 and 506 points to the webpage that carries corresponding perspective, or points to the perspective database 322, and through which, is redirected to the corresponding webpage. Through the later way, the service provider 320 can collect certain usage information to improve service.

In this way, even if the webpage 500 is created after the webpage 300 is created, that is, the perspective 504 was not available when the perspective 304 is created, a viewer who, through a search engine, or a social network, or a content recommendation and personalization service, lands on webpage 300 can still access the new perspective 504 from webpage 300 as illustrated in FIG. 7. This mechanism is called future reference therein.

In one embodiment of the invention, there is no fixed, for example 1 to 1 mapping relationship between subject, perspective and webpage. One webpage may cover multiple subjects, or one subject is mapped to multiple webpages, or one webpage covers multiple perspectives, or one perspective is mapped to multiple webpages, or one subject is mapped to multiple perspectives, or one perspective is mapped to multiple subjects. In any situation, related webpage, subject and perspective all have a linking relationship and they are linked to each other. This mechanism is called O-Link therein, which stands for open link.

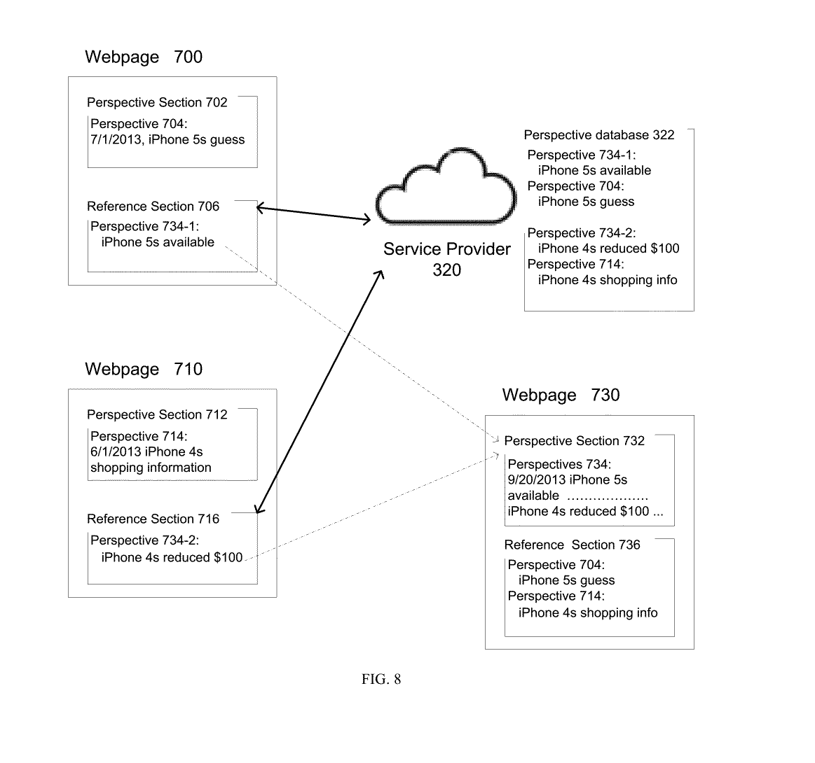

FIG. 8 illustrates an example of mapping and linking relationships among webpages according to an embodiment of the present invention. As shown in FIG. 8, there are 3 webpages. A webpage 700 is an article which guesses the design and specifications of iPhone 5s, published on Jul. 1, 2013. This is taken as one perspective 704 and one item is created in the perspective database 322 and indexed under iPhone 5s. A webpage 710 is an article which talks about iPhone 4s shopping information, published on Jun. 1, 2013. This is taken as one perspective 714 and one item is created in the perspective database 322 and indexed under iPhone 4s. A webpage 730 is an article which reports iPhone 5s is released and iPhone 4s reduced price, published on Sep. 20, 2013. This is taken as two perspectives 734-1 and 734-2 and two items are created in the perspective database 322 and indexed under iPhone 5s and iPhone 4s respectively. Before Sep. 20, 2013, when the webpage 700 or the webpage 710 is viewed, their reference sections 706 and 716 are empty. After Sep. 20, 2013, when webpage 700 or webpage 710 is viewed, their reference section 706 and 716 will have an item that links to the new information. Assuming the webpage 730 is from a minor unpopular website which is ranked low that the webpage 730 is listed on the second page when searching “iPhone 5s” while the webpage 700 is listed on top of the search result, a user will see the webpage 700 first and won't see the newer webpage 730 until he or she sees the link on the second page in the search result. A user may even miss webpage 730 if he or she doesn't walk to the second page. Yet with the method according to an embodiment of the present invention, a user who first lands on webpage 700 will be able to see the latest iPhone 5s release information from the reference section 706 of the webpage 700, which is more efficient and minimize the chance the webpage 730 being missed. In the same way, a user who lands on the webpage 710 for iPhone 4s shopping will be able to see the latest price reduction news for iPhone 4s from the reference section 716 of the webpage 710.

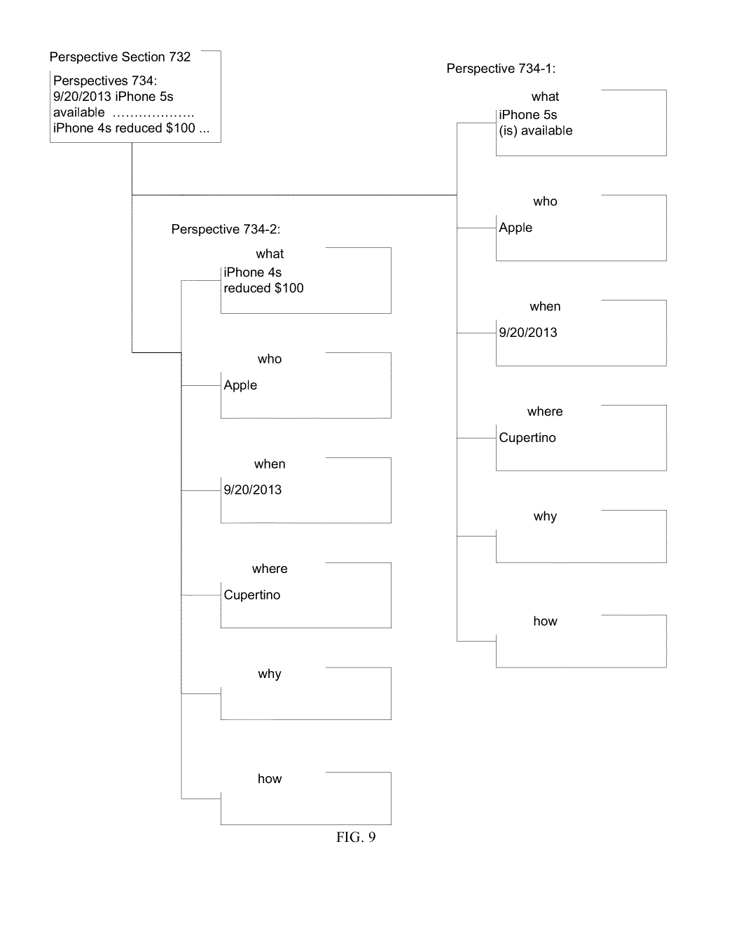

In one embodiment of the present invention, the service provider 320 can use algorithms to extract one or multiple perspectives automatically from a webpage. FIG. 9 illustrates an example of information extraction. As shown in FIG. 9, the webpage 730 from the example in FIG. 8 is analyzed and information is extracted into the fields of “what”, “who”, “when”, “where”, “why” and “how” for the subject, i.e., the people, the time, the location, the situation and the event, etc. While most perspectives can be represented by “what”, “who”, “when” and “where”, “why” is useful to analyze the cause of a problem and “how” is useful to provide a solution of a problem. In the example, the webpage 730 is extracted into two perspectives of iPhone 5s 734-1 and iPhone 4s 734-2 respectively.

In one embodiment of the invention, the service provider 320 can provide an interface or a tool for the user, for example an author of a webpage or a viewer of a webpage, to submit the webpage to make sure its perspective is stored in the perspective database 322, or to make sure it is stored appropriately. The service provider 320 can, through the interface or tool, pre-fill the fields of “what”, “who”, “when”, “where”, “why” and “how” with the information pre-extracted from the webpage for the user to review and confirm or to revise.

In one embodiment of the present invention, the service provider 320 uses a thesaurus 924 to link perspectives which are described by different synonym words or phrases. FIG. 10 illustrates the process of using a thesaurus to link perspectives. As shown in FIG. 10, a webpage 900 and a webpage 910 are both talking about the same subject of “rainforest destruction”, but on perspective of “causes” 904 and “effects” 914 respectively. And they use different keywords. The webpage 900 uses “deforestation” and the webpage 910 uses “forest destruction”. As indicated in the thesaurus 924, “deforestation”, “forest destruction”, “rainforest destruction”, “disforestation”, “forest destroy” are usually used to describe the same subject deforestation. The two perspectives 904 and 914 are indexed under the same subject and the perspectives are linked.

In one embodiment of the invention, the service provider 320 may provide an interface or a tool for a user to submit synonym words or phrases to make sure they are stored as synonyms in the thesaurus 924.

In one embodiment of the invention, the service provider 320 may provide an interface or a tool for a user to submit a perspective, which is not indexed by the service provider 320, to the service provider 320 to link it to a perspective that is related to the same subject. For example in the example of FIG. 10, assuming a webpage 900 is already indexed in the perspective database 322 and a user finds a webpage 910 and notices it is related to the same subject as the webpage 900 but not indexed and not linked to the webpage 900, the user can, through the interface or tool, submit the webpage 910 to the service provider 320 to suggest the webpage 910 to be indexed and linked to the webpage 900. If both of the webpage 900 and the webpage 910 are not indexed and a user views the webpage 900 and the webpage 910 separately and notices they are related to the same subject and very informative but not indexed and not linked, the user can, through the interface or tool, submit both webpages to the service provider 320 to suggest them to be indexed and linked.

In one embodiment of the invention, for the perspective database 322, the service provider 320 can choose different indexing algorithms to order and organize perspectives that are available, for example, popularity of linking references, popularity voted by viewers, distinctness of the perspectives or publishing time of perspectives etc.

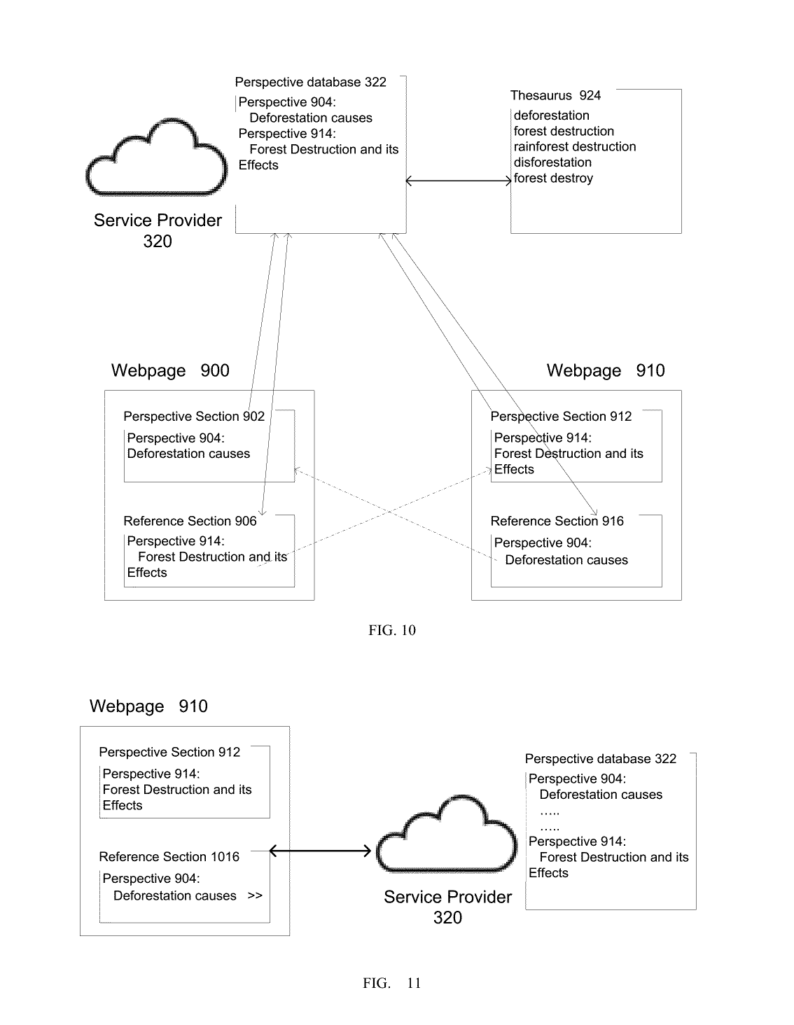

FIG. 11 illustrates an example of duplicate perspectives. As shown in FIG. 11, duplicate perspectives are grouped in the perspective database 322 and only one selection item is retrieved and displayed in the reference sections. Such selection can carry a special mark to indicate a viewer there are multiple duplicate perspectives available and one can expand and explore them from the special mark. For example in FIG. 11, there are many webpages talking about the causes of deforestation. These webpages representing one single perspective are grouped in the perspective database 322. When the webpage 910 is viewed, one link pointing to the perspective 904 is displayed in a reference section 1016, with a special mark “>>” indicating that duplicate perspectives are available and omitted and that the viewer can expand it to explore further. When the special mark is clicked, the omitted duplicate perspectives will be provided to the viewer.

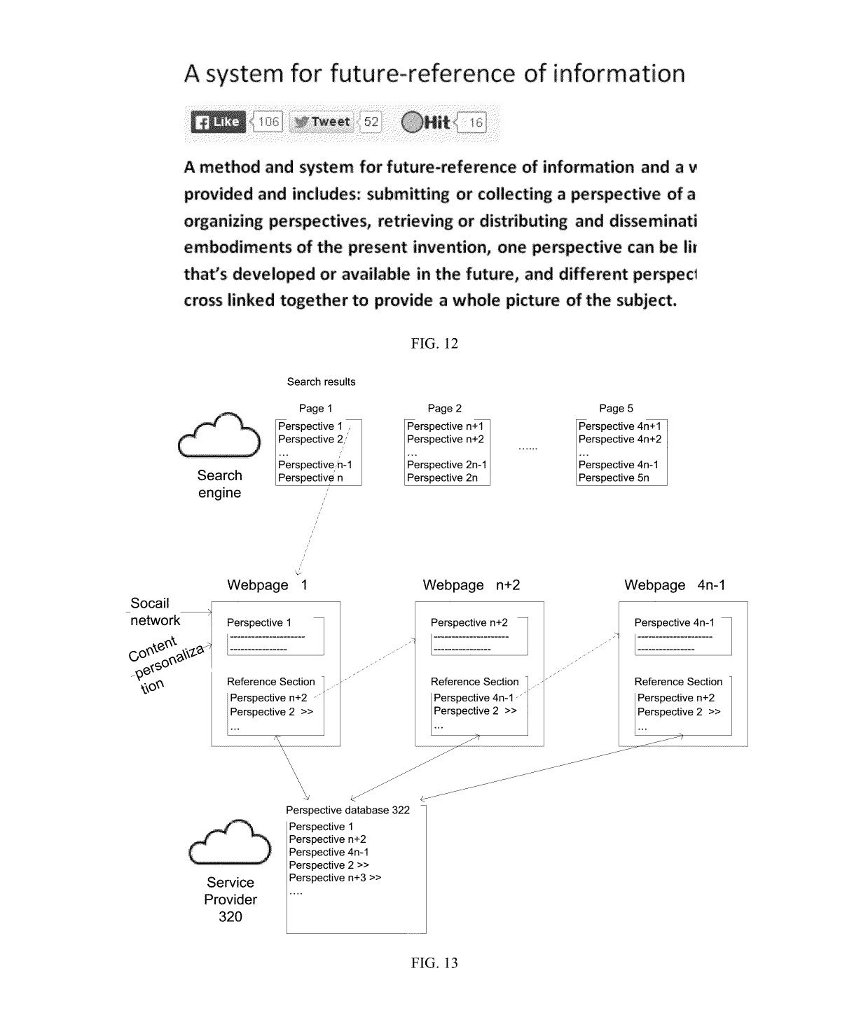

In one embodiment of the invention, the service provider 320 may provide an interface or a tool for a web site to deploy on its webpages to count whether a viewer thinks the article hits a point. FIG. 12 illustrates an example of such a counting interface deployed next to the Twitter counter in one embodiment of the invention. As shown in FIG. 12, similar to the Facebook and the Twitter interface, the counting interface comprises two parts, a button labeled “Hit” and a counter. While the Facebook and the Twitter interfaces help spread or distribute the article through their social network, the “Hit” counting interface helps collecting and measuring how a viewer evaluates the quality of the article. When a viewer thinks the article hits a point, he or she can click the button which sends the click to the service provider 320. The service provider 320 counts it and the counter is updated. The service provider 320 can employ a certain mechanism to control the update of such counts, for example, one needs to be registered and only registered users can hit only once. In one embodiment of the invention, the service provider 320 can use the hits count as a popularity parameter measurement voted by viewers to index and order a perspective.

With the embodiments of the invention, the user can get a whole picture on a subject from all or most of the perspectives that are available from the reference section of a webpage that are cross-linked together through the O-Link mechanism, or can walk through perspectives from the perspective database 322 at the service provider 320. In any situation, instead of being positioned in a search result list dictated by a monopoly search engine, with an open environment where related webpages are cross linked and where users can participate and contribute, that instead of worrying about the popularity of their works, the authors can focus on providing quality information and making a point; and instead of spending time walking through duplicate perspectives, or obsolete perspectives, or trying different keywords in order not to miss a perspective, a user can focus on studying perspectives one by one and understanding the subject, and can help improving the service by submitting new perspectives and providing feedback.

FIG. 13 illustrates comparison of the method according to an embodiment of the present invention and an existing search engine. As shown in FIG. 13, in an example, for a subject there are 5n perspectives as listed in 5 pages of the search result. Assuming only perspectives 1, 2, n+2, n+3, and 4n−1 are distinctive and they are processed as described above so that they are indexed and ordered in the way as shown in the perspective database 322, while perspectives 2 through n+1 are duplicate and obsolete and ranked below perspective n+2. In the search result, a user has to walk through 5 pages to reach the distinct perspectives. But with the method according to an embodiment of the present invention, when a user lands on page 1 either from the search result, or from a social network, or from a content personalization service, he or she will be able to land on page n+2 and then on page 4n−1 from the links in the reference section of the related webpages. Or the user can walk through the distinct perspective through the perspective database 322. In either situation, the user doesn't have to walk through 5 pages of duplicate or obsolete perspectives.

While many webpages may have a section which looks similar to the reference section in the invention. They are only similar in the visual form. Behind the visual form, how the content is created, indexed and obtained and what purposes the content serves are totally different. As of the writing of this invention, the content in the existing sections serves two types of purposes: content recommendation and advertisement. Literally the content doesn't serves as reference at all. The content recommendation operates mainly on the principle of a webpage reader's interest, called interest graph, mainly derived from a reader's activity, for example, what content a reader spends time on or what links a reader clicks. There are quite a few of such content recommendation services in various names, for example, “Recommended for you”, or “Further reading”, or “You may also like”, or “Trending”, or “What You Missed”, or “Readers who have read this, also read these”, etc. While some services call it “content personalization”, most of them don't bother go beyond a web site, due to a hidden agenda—to engage a reader, or to keep a reader to spend as much time as possible on the web site, walking through webpages within certain categories that a reader may have showed interest. The level at which such services deal with the content stops at the category level, for example, technology, sport, and art etc. A reader will notice that webpages for different subjects carry the same content recommendation.

The present invention is advantageous. It can go across web sites to extract or receive from a user one or multiple perspectives for a subject, and link different, ideally complementary or orthogonal perspectives, or link developmental perspectives together to construct a whole picture of a subject. The goal is to serve a reader with a whole picture of a subject in a more efficient way.

Although the present invention has been described in terms of various embodiments, it is not intended that the invention be limited to these embodiments. Modification within the spirit of the invention will be apparent to those skilled in the art. For example, a perspective can be created and presented in a webpage or in a smartphone application.

The interface or tool the service provider provides can be in a webpage, or a webpage application, or a smartphone application.

Thus it should be understood that the embodiments described herein should be considered in a descriptive sense only and not for purposes of limitation. Descriptions of features or aspects within each embodiment should typically be considered as available for other similar features or aspects in other embodiments. Various changes in form and details may be made therein without departing from the spirit and scope of the present invention as defined by the following claims and their equivalents.

What is claimed is:

1. A method for displaying webpages, comprising:
submitting, by a client, a link to a webpage providing a perspective on a subject to a service provider;
extracting, by the service provider, the perspective from the webpage, indexing the extracted perspective on the subject, and storing the indexed perspective in a perspective database which stores all indexed perspectives on the subject from different webpages;
retrieving, by the client, references to other perspectives on the subject from the service provider; and
displaying, by the client, the references to other perspectives on the subject when displaying the webpage.

2. The method of claim 1, wherein the perspective on the subject is displayed in a perspective section of the webpage, and the references to other perspectives on the subject are displayed in a reference section of the webpage.

3. The method of claim 1, wherein extracting the perspective from the webpage comprises: analyzing the webpage and extracting information included in the webpage into fields of “what”, “who”, “when”, “where”, “why” and “how”.

4. The method of claim 3, further comprising providing an interface or a tool for a user to revise contents in the fields of “what”, “who”, “when”, “where”, “why” and “how”.

5. The method of claim 1, further comprising using a thesaurus by the service provider to link perspectives described by different synonym words or phrases, wherein the linked perspectives are indexed and stored in a same perspective database.

6. The method of claim 5, further comprising providing an interface or a tool for a user to submit the synonym words or phrases.

7. The method of claim 1, further comprising providing an interface or a tool for a user to submit a perspective to the service provider to link the perspective to other perspectives on the same subject.

9. The method of claim 1, wherein the link to the webpage providing the perspective on the subject is submitted to the service provider when the webpage is created.

10. The method of claim 9, wherein the link to the webpage is submitted to the service provider automatically by the client, or manually by a user, or upon request of the service provider.

11. The method of claim 1, wherein the perspectives are ordered in the perspective database according to a predefined algorithm.

12. The method of claim 11, wherein the predefined algorithm is one of popularity of linking references, popularity voted by viewers, distinctness of the perspectives and publishing time of the perspectives.

13. The method of claim 12, further comprising providing an interface or a tool for counting whether a user thinks an article hits a point, and using the counting result as the popularity voted by viewers.

14. The method of claim 1, wherein only one reference is displayed among a plurality of references for duplicate perspectives.

15. The method of claim 14, further comprising displaying a special mark when displaying the only one reference among the plurality of references for duplicate perspectives.

16. The method of claim 15, further comprising expanding the special mark to display other references among the plurality of references for duplicate perspectives.
